(19) United States
(12) Patent Application Publication
(10) Pub. No.: US 2019/0323133 A1
(43) Pub. Date: Oct. 24, 2019

(54) METHOD OF PRODUCING AMMONIUM PERSULFATE

(71) Applicant: Toray Industries, Inc., Tokyo (JP)

(72) Inventors: Mio Yoshii, Tokyo (JP); Mikihito Tezuka, Tokai-shi (JP); Fumio Fukuda, Tokai-shi (JP)

(21) Appl. No.: 16/475,738

(22) PCT Filed: Dec. 27, 2017
(86) PCT No.: PCT/JP2017/047065

§ 371 Date: Jul. 3, 2019

(30) Foreign Application Priority Data
Jan. 13, 2017 (JP) 2017-003993
Aug. 24, 2017 (JP) 2017-161111

(51) Int. Cl. C25B 1/28; C01C 1/24; C25B 9/10; C25B 11/03; C25B 11/04

(52) U.S. Cl. CPC C25B 1/285; C01C 1/24; C25B 11/0415; C25B 11/03; C25B 9/10

(57) ABSTRACT

A method of producing ammonium persulfate by electrolyzing ammonium sulfate is characterized in that an ammonium sulfate aqueous solution is supplied as an anode-side feedstock, a solution containing less than 1.0 mol of acid-derived acid dissociable hydrogen ions per 1.0 mol of amount of charge transfer is supplied as a cathode-side feedstock, and electrolysis is performed to produce ammonium persulfate on the anode side and at least ammonia on the cathode side. Since ammonium sulfate not dependent upon the ammonium sulfate produced within the system can be used as a main feedstock, the method is industrially advantageous and, further, because of an electrolytic method, the method enables the coproduction not only of ammonium persulfate but also of valuable materials such as ammonia and hydrogen and, furthermore, enables the production of ammonium persulfate at a high current efficiency.

### TECHNICAL FIELD

This disclosure relates to a method of producing ammonium persulfate using ammonium sulfate as a feedstock and, specifically, to a method of producing ammonium persulfate that can produce ammonia persulfate and simultaneously coproduce ammonia.

### Background

Ammonium sulfate was once synthesized as a target substance, but now it is mainly marketed as a byproduct obtained in an industry for organic chemical such as caprolactam, laurolactam, acrylonitrile, methyl methacrylate or in a coke production process due to coal dry distillation. Since ammonium sulfate contains about 20% ammonia nitrogen, it is possible to use it as a fertilizer, and most of ammonium sulfate obtained as a byproduct in the above-described processes is used for a fertilizer. However, since ammonium sulfate has sulfuric acid roots, it also has negative aspects in plant growth such as soil acidification and salt formation, and the amount of fertilization is limited. For this reason, most of ammonium sulfate obtained as a byproduct nowadays in Japan is exported under the present circumstances.

As a method of coping with such problems, conventionally, processes of producing caprolactam, acrylonitrile or methyl methacrylate that do not create ammonium sulfate as a byproduct have been developed. However, these processes have problems such as complicated processes or difficulty in converting from existing processes. Therefore, many ammonium sulfates are still created as byproduct in large excess, and are currently exported at low prices.

On the other hand, ammonium persulfate is widely and industrially utilized mainly as a polymerization initiator for emulsion polymerization, an oxidation bleach, copper etching agent and the like. As a method of producing ammonium persulfate which has been known up to now, as an anode-side feedstock of an electrolytic process, a method using an aqueous solution containing ammonium hydrogen sulfate as described in JP-A-SHO 57-198275, a method using a an aqueous solution of ammonium sulfate alone as described in JP-A-HEI 11-293484, and a method using ammonium sulfate and ammonium persulfate as described in JP-A-2001-220695, are known. As the cathode-side feedstock, in any of the methods, only aqueous sulfuric acid solution or aqueous sulfuric acid solution containing salt is selected, and in any event, the amount of charge transfer due to electrolysis has been controlled to less than the amount of sulfuric acid-derived acid dissociable hydrogen ions. In other words, all of the cathode-side electrolytic reactions have been carried out only in the reaction in which the sulfuric acid-derived hydrogen ion becomes a hydrogen molecule as shown in the following reaction formula.

2H⁺+2e⁻→H₂

In that method, since hydrogen ion of sulfuric acid is consumed, and is exchanged with ammonium ion that has been electrophoresed from the anode side, an ammonium sulfate aqueous solution is obtained as a cathode-side product. This aqueous solution has been reused as an anode-side feedstock.

For example, as shown in FIG. 1, ammonium sulfate ((NH₄)₂SO₄) is supplied to the anode side 2 of electrolyzer 1 as an anode-side feedstock, and as an anode reaction, sulfuric acid is reacted (consumed) as follows. Persulfuric ion is caused.

2SO₄²⁻→S₂O₈²⁻+2e³¹

Dissolved ion is as follows:
before electrolysis: NH₄⁺, SO₄²⁻=ammonium sulfate aqueous solution,
after electrolysis: NH₄⁺, S₂O₈²⁻=ammonium persulfate aqueous solution,
ammonium ion electrophoreses to the cathode side, and ammonium persulfate aqueous solution is produced.

On the other hand, on the cathode side 3, sulfuric acid is supplied, and as a cathode reaction, sulfur acid-derived hydrogen ions react (consume) and hydrogen gas is generated as shown in the following reaction formula.

2H⁺+2e⁻→H₂

Dissolved ion is as follows:
before electrolysis: H⁺, SO₄²⁻=sulfuric acid aqueous solution,
after electrolysis: NH₄⁺, H⁺, SO₄²⁻=ammonium sulfate aqueous solution,
the ammonium ion electrophoresed from the anode side is concentrated, and an ammonium sulfate aqueous solution is produced. Ammonia is further added to this ammonium sulfate aqueous solution to make it ammonium sulfate, and the ammonium sulfate is reused as the anode-side feedstock.

As described above, although ammonium sulfate is utilized as the anode-side feedstock, since the ammonium sulfate aqueous solution is generated on the cathode side and it is reused as the anode-side feedstock, in such a process of producing ammonium persulfate, it was not possible to use a large amount of ammonium sulfate, which is a byproduct produced from other processes cheaply and excessively, and it was necessary to use ammonia and sulfuric acid as feedstocks.

Accordingly, it could be helpful to provide a method capable of utilizing a large amount of ammonium sulfate produced as a byproduct in other processes cheaply and excessively as an anode-side feedstock, in particular, capable of producing ammonia that can be effectively utilized in various processes without generating ammonium sulfate which has been conventionally reused, and besides, capable of producing ammonium persulfate with a high efficiency.

### Summary

We thus provide a method of producing ammonium persulfate (chemical formula: (NH₄)₂S₂O₈) by electrolyzing ammonium sulfate (chemical formula: (NH₄)₂SO₄) characterized in that an ammonium sulfate aqueous solution is supplied as an anode-side feedstock, a solution containing less than 1.0 mol of acid-derived acid dissociable hydrogen ions per 1.0 mol of amount of charge transfer is supplied as a cathode-side feedstock, and electrolysis is performed to produce ammonium persulfate on the anode side and at least ammonia on the cathode side.

Namely, the method of producing ammonium persulfate suppresses the amount of acid dissociable hydrogen ions of the cathode-side feedstock to an amount less than the amount of charge transfer due to the electrolysis and supplies the feedstock to the cathode side (cathode chamber), and by electrolysis, produces ammonium persulfate on the anode side similarly in the conventional technology and produces at least ammonia, more specifically, for example, ammonia hydroxide/ammonia gas and hydrogen gas on the cathode side.

In the method of producing ammonium persulfate, as the solution containing less than 1.0 mol of acid-derived acid dissociable hydrogen ions per 1.0 mol of amount of charge transfer, which is supplied as the above-described cathode-side feedstock, although water can also be used, to efficiently perform the electrolysis and the reaction, it is preferred to use an electrolyte-containing solution. As such a cathode-side feedstock solution, an ammonium sulfate solution can be used, a solution containing sulfuric acid can also be used, and an ammonium hydroxide solution can also be used, as long as the above-described condition of the amount of acid dissociable hydrogen ions less than the amount of charge transfer due to the electrolysis is satisfied. It is also possible to use a mixed solution of these solutions. When an ammonium sulfate aqueous solution is used as the cathode-side feedstock, the concentration thereof is preferably 30 to 45% by weight. To obtain the maximum ammonia production amount per amount of charge transfer, in other words, to further increase ammonia production efficiency, a solution containing sulfuric acid having acid dissociable hydrogen ions at a high concentration is not preferred as the cathode-side feedstock.

Further, the concentration of the ammonium sulfate aqueous solution as the anode-side feedstock is preferably 30 to 45% by weight. More preferably, it is 40 to 45% by weight. By using such a high concentration ammonium sulfate aqueous solution as the anode-side feedstock, ammonium persulfate can be produced industrially advantageously. Both the anode side and the cathode side may be a batch system for the feedstock supply and product delivery systems, but the continuous system is more industrially advantageous.

As aforementioned, the ammonium persulfate produced by the method of producing ammonium persulfate can be widely used industrially as a polymerization initiator for emulsion polymerization, an oxidation bleach, copper etching agent and the like, and ammonia can be utilized in various processes in addition to the lactam production process described later, and hydrogen can be utilized as a hydrogenation process of organic chemical industry, fuel for fuel cells or the like.

Thus, according to the method of producing ammonium persulfate, because ammonium sulfate that does not depend on ammonium sulfate generated in the system can be used as a main feedstock, it is industrially advantageous and, further, because it is an electrolytic process, not only ammonium persulfate but also valuable materials such as ammonia and hydrogen can be co-produced and, furthermore, it is possible to provide a method of producing ammonium persulfate which can produce it with a high current efficiency of ammonium persulfate production of 80% or more, more preferably 85% or more, particularly preferably 90% or more.

### BRIEF DESCRIPTION OF THE DRAWINGS

FIG. 1 is a schematic block diagram showing an example of a conventional method of producing ammonium persulfate.

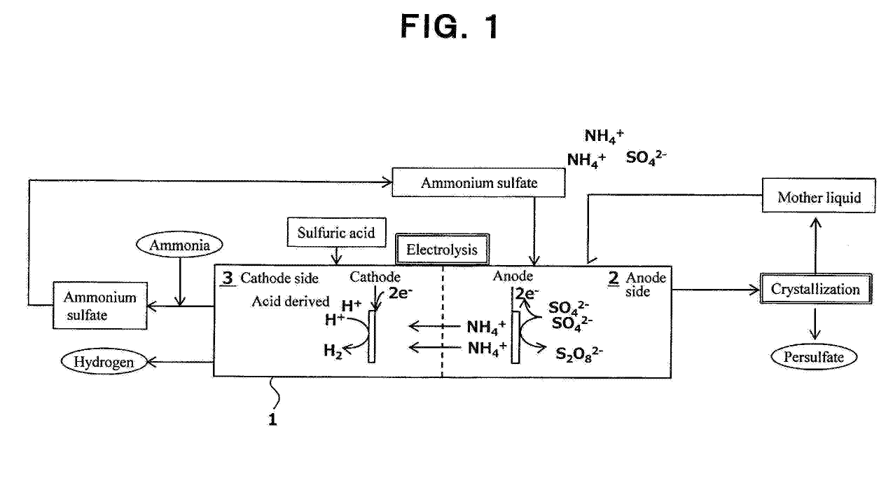

FIG. 2 is a schematic block diagram showing our method of producing ammonium persulfate according to an example.

### EXPLANATION OF SYMBOLS

1, 11: electrolyzer
2, 12: anode side
3, 13: cathode side
14: other production processes

### DETAILED DESCRIPTION

Hereinafter, our methods will be explained in more detail together with examples.

Our method of producing ammonium persulfate is a method of producing ammonium persulfate by electrolyzing ammonium sulfate characterized in that an ammonium sulfate aqueous solution is supplied as an anode-side feedstock, a solution containing less than 1.0 mol of acid-derived acid dissociable hydrogen ions per 1.0 mol of amount of charge transfer is supplied as a cathode-side feedstock, and electrolysis is performed to produce ammonium persulfate on the anode side and at least ammonia on the cathode side.

As the anode-side feedstock, for example, an ammonium sulfate aqueous solution containing ammonium ion of amount of charge transfer or more can be used, and sulfuric acid and ammonium hydroxide may be in an excess state. Although the concentration is not particularly limited, industrially, the higher the concentration is, the more advantageous it is, and a concentration range of 30 to 45% by weight of ammonium sulfate is preferable. Although the anode-side feedstock contains a necessary amount of polarizer, the polarizer is not particularly limited as long as it is advantageous for a known production of persulfate. As preferred polarizers, guanidine, guanidine salt, thiocyanate, cyanide, cyanate, fluoride and the like are used. A particularly preferred one is guanidine or guanidine salt. As the guanidine salt, guanidine sulfamate, guanidine nitrate, guanidine sulfate, guanidine phosphate, guanidine carbonate or the like, can be exemplified. As the concentration of the polarizer, 0.01 to 1% by weight with respect to the anode side feedstock can be exemplified, and it is preferably 0.01 to 0.05% by weight.

The cathode-side feedstock is not particularly limited as long as it is a solution composed of acid dissociable hydrogen ions with less than 1.0 mol per 1.0 mol of amount of charge transfer due to electrolysis and, for example, a dilute sulfuric acid solution can be used. In this example, since sulfuric acid is a diprotic acid, to satisfy the above-described condition of the acid dissociable hydrogen ion amount, concretely, it becomes a sulfuric acid solution of less than 0.5 mol. If the above-described condition of the acid dissociable hydrogen ion amount is satisfied, pure water or an aqueous solution containing a base such as ammonium hydroxide or a salt such as ammonium sulfate may be used. Preferably, if an ammonium sulfate aqueous solution or ammonium hydroxide aqueous solution is used, the electrical resistance is reduced because it contains an electrolyte, and since it is composed of ions having the same composition as the anode side feedstock separated from a diaphragm and, further, sulfuric acid-derived acid hydrogen ion subjected to a cathode reaction does not exist, maximum ammonia can be produced. Although the concentration is not particularly limited with respect to ammonium sulfate, industrially, the higher the concentration is, the more advantageous it is, and a concentration range of 30 to 45% by weight is more preferable. When sulfuric acid is used, ammonium sulfate is preferentially generated in the cathode produced solution during the initial step of the reaction, and the ammonia production efficiency per unit amount of charge transfer is reduced and, therefore, a dilute solution is preferred, and the concentration of sulfuric acid may be less than 0.5 mol relative to 1.0 mol of the amount of charge transfer due to electrolysis, and concretely, 0.001 to 1% by weight of sulfuric acid aqueous solution is preferable. In an ammonium hydroxide aqueous solution, it is not particularly limited. Further, industrially, it is more preferable to use an ammonium sulfate aqueous solution or an ammonium hydroxide aqueous solution than to use sulfuric acid, from the viewpoint of ammonia production efficiency and the selection of materials used for cathode by reducing corrosiveness caused by sulfuric acid.

By making the cathode-side feedstock into the above-described composition, reaction formula (1) is prioritized in the range where sulfur acid-derived hydrogen ion is present in the anode liquid, and hydrogen is generated as a cathode-side product, but after the acid-derived hydrogen ion has reached to a condition of deficiency, reactions such as reaction formula (2) and reaction formula (3) are prioritized. Since the equilibrium reaction of reaction formula (4) exists in the system, hydrogen and ammonia can be generated as cathode-side products in any of reaction formulae (2) and (3).

2H⁺+2e⁻→H₂ (1)

2NH₄⁺+e⁻→2NH₃+H₂ (2)

2H₂O+2e⁻→H2+2OH⁻ (3)

NH₄⁺+OH⁻⇄NH₃+H₂O (4)

The electrolyzer is not particularly limited, and may be an electrolyzer divided into an anode chamber and a cathode chamber, which are separated by a diaphragm. A box type electrolyzer or a filter press type electrolyzer can be used. For the diaphragm that separates the anode chamber and the cathode chamber, a diaphragm that can inhibit the electrophoresis of the anion generated in the anode chamber to the cathode chamber is used. As the diaphragm, a cation exchange membrane, a neutral alumina diaphragm or the like can be exemplified, and preferably, a cation exchange membrane is used.

The anode is preferably platinum or platinum group, but a known material with a high oxygen overvoltage such as a conductive diamond electrode can also be used. As the cathode, preferably, lead, zirconium, platinum, nickel, and a stainless steel such as SUS 316 can be used. Further, as the electrode, a wire mesh made of these metals can be used.

The current density of the anode is preferably 20 A/dm2 or more. If it is lower than this, the current efficiency may be low. Preferably, it is 40 A/dm2 or more, and preferably 500 A/dm2 or less, more preferably 200 A/dm2 or less, and particularly preferably 80 A/dm2 or less. Industrially, operation at a high current density is more preferred because the device size can be reduced. The temperature in the electrolyzer is preferably 15 to 40° C. By setting this range, dissolution of salts in the electrolyzer can be maintained in an appropriate range, and undesirable side reactions can be suppressed, that are preferred.

By employing our production method, ammonium persulfate can be produced with a high current efficiency. Under preferable conditions, ammonium persulfate can be produced at a current efficiency of 80% or more, more preferably at a current efficiency of 85% or more, particularly preferably 90% or more. The upper limit of the current efficiency is theoretically 100%. The current efficiency (%) is a value represented by (generated persulfuric ion (mol)×2)/current magnitude (F)×100, and it can be calculated by measuring the amount of persulfuric ion generated per unit current magnitude.

Since persulfuric ion is generated in the anode solution by electrolysis at a state where the anode solution is filled in the anode chamber, this anode produced solution is supplied to, for example, a widely used crystallization tank similarly to in the conventional technology, thereby making it possible to perform a concentration crystallization. The ammonium persulfate-containing slurry after crystallization is separated into ammonium persulfate crystals and a crystallization mother liquid by a solid-liquid separator such as a centrifugal separator used widely and commonly. The obtained ammonium persulfate crystals can be dried and commercialized using a powder drier. The crystallization mother liquid can be re-supplied to the process as an anode-side feedstock.

Further, by performing electrolysis by applying an electric current of the aforementioned amount of charge transfer or more at a state where a cathode solution is passed through the cathode chamber, a mixed gas of hydrogen and ammonia in a cathode produced gas in the cathode chamber and/or ammonium hydroxide (ammonia-containing water) in the cathode produced solution is produced. The hydrogen-ammonia mixed gas produced on the cathode side can be separated by ammonia gas separation methods used widely and commonly, for example, such as cryogenic separation and compression separation. Further, when the destination of supplying the produced ammonia is a process supplied as ammonia water, for example, such as a neutralized salt conversion process in a lactam process, it can be separated using a gas absorption tower used widely and commonly and can also be recovered as ammonia water.

The separated hydrogen gas can be purified and compressed using a pressure swing adsorption method or the like, and can be utilized for a hydrogenation process of organic chemical industry or as fuel for fuel cells.

In our method of producing ammonium persulfate, ammonium sulfate produced as a byproduct in the aforementioned production process of lactam, acrylonitrile, methyl methacrylate or the like and coke production process by coal dry distillation can used as the feedstock. In this connection, the byproducts containing ammonium sulfate in various processes may contain impurities other than ammonium sulfate or the like, and depending upon their components and contents, by occurrence of side reactions, the current efficiency in the production process of ammonium persulfate may decrease. In such an example, it is preferred to purify the byproduct containing ammonium sulfate in advance to reduce the components that reduce the current efficiency, and then supply it to the ammonium persulfate production process.

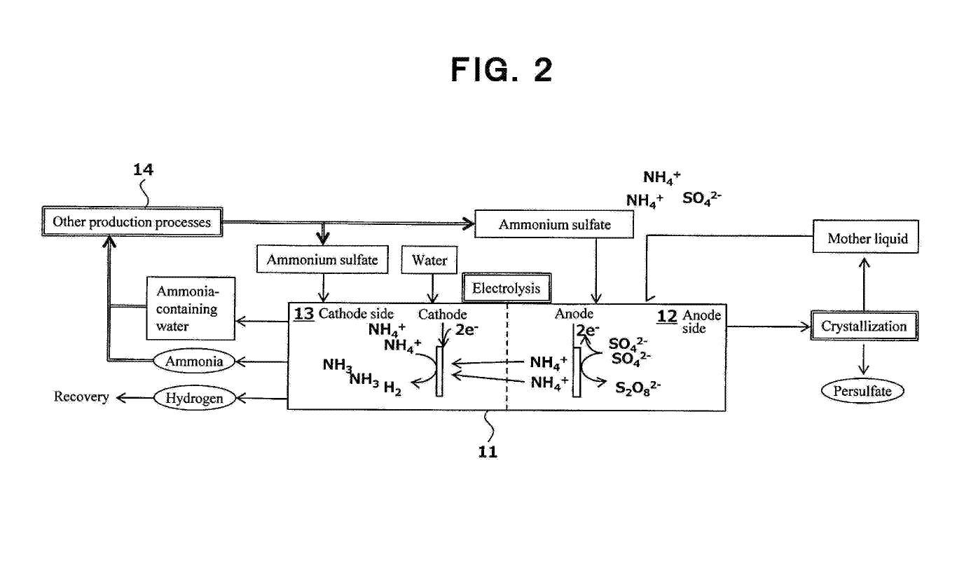

As a concrete example of the method of producing ammonium persulfate, FIG. 2 exemplifies using ammonium sulfate (abbreviation thereof) solution as the cathode-side feedstock solution. In FIG. 2, symbol 11 indicates an electrolyzer, and ammonium sulfate ((NH₄)₂SO₄) produced as a byproduct, for example, in a lactam production process 14 as other production processes 14 is supplied to the anode side 12 of the electrolyzer 11 as the anode-side feedstock, and as the anode reaction, sulfuric ion is reacted (consumed) to generate persulfuric ion, as shown in the following description, similarly to in the conventional technology.

2SO₄²⁻→S₂O₈²⁻+2e⁻

Dissolved ion is as follows:
before electrolysis: NH₄⁺, SO₄²⁻=ammonium sulfate aqueous solution,
after electrolysis: NH₄⁺, S₂O₈²⁻=ammonium persulfate aqueous solution,
ammonium ion electrophoreses to the cathode side, and ammonium persulfate aqueous solution is produced. This solution produced on the anode side is concentrated and crystallized to be separated into a crystallization mother liquid and crystals, and the crystals can be commercialized as a salt of ammonium persulfate by, for example, a powder drier. The crystallization mother liquid can be re-supplied to the process as the anode-side feedstock.

On the other hand, on the cathode side 13, water and an ammonium sulfate solution (an abbreviation thereof solution) comprising ammonium sulfate produced as a byproduct in, for example, lactam production process 14 are supplied and as the anode reaction, because hydrogen ion of reaction source is not present or is poor, as shown in the following reaction formula, ammonium ion electrophoresed from the anode is reacted to produce ammonia and hydrogen. Further, when a small amount of acid is present on the cathode side 13, acid-derived hydrogen ions react (consume) to generate hydrogen gas as shown in the following reaction formula.

2NH₄⁺+2e⁻→2NH₃+H₂

2H⁺+2e⁻→H₂ (when a small amount of acid is present)

The dissolved ion, to explain when ammonium sulfate solution (abbreviation thereof solution) comprising ammonium sulfate is supplied to the cathode side 13, is as follows:
before electrolysis: NH₄⁺, SO₄²⁻=ammonium sulfate aqueous solution,
after electrolysis: NH₄⁺, SO₄²⁻=ammonium sulfate aqueous solution,
and substantially there is no change. Namely, except for when a small amount of acid is present on the cathode side 13 and the acid-derived hydrogen ion reacts (consumes) as described above, the dissolved ion on the cathode side 13 does not substantially change.

Thus, on the cathode side 13, ammonia, ammonia-containing water, and hydrogen are produced without producing ammonium sulfate, and ammonia and ammonia-containing water can be used for the lactam production process or the like, and the hydrogen is recovered and can be used in various fields.

### Examples

Hereinafter, our methods will be concretely explained by way of examples, but this disclosure is not limited at all by the examples. The current efficiency in the examples is represented by (generated persulfuric ion (mol)×2)/current magnitude (F)×100%, and it represents the ratio of persulfuric ion generated per unit current magnitude.

### Example 1

Using a transparent acrylic electrolyzer separated by cation exchange membrane (Nafion (registered trademark) 117, supplied by Chemours Corporation) as a diaphragm, an electrode comprising an 80 mesh platinum wire mesh and titanium was used as the anode, and an electrode comprising an 80 mesh SUS 316 wire mesh was used as the cathode. To the anode chamber, 500 g of an aqueous solution adding 0.03 wt % of guanidine sulfamate as a polarizer to a 43 wt % ammonium sulfate aqueous solution was supplied. As the substance mass of the respective ions, ammonium ion is 3.25 mol, and sulfuric ion is 1.63 mol. 500 g of 43 wt % ammonium sulfate aqueous solution was supplied to the cathode chamber. The anode current density was then energized at 45 A/dm2. The amount of charge transfer was 0.67 mol. The amount of charge transfer can be determined by a value of the amount of current flow x time of current flow. After energization, the concentration of ammonium persulfate in the resulting anode produced solution was measured by titration. In the anode, 0.315 mol of ammonium persulfate was produced, and the current efficiency was 94%. Further, generation of hydrogen and ammonia corresponding to the amounts of electrolytic reaction was recognized from the cathode generated gas during the electrolysis.

### Example 2

The energization was performed at an anode current density of 6.43 A/dm2 using the same device as in Example 1 and the same anode chamber feed solution composition and cathode chamber feed solution composition. The amount of charge transfer was 0.67 mol. After energization, the concentration of ammonium persulfate in the resulting anode produced solution was measured by titration. In the anode, 0.311 mol of ammonium persulfate was produced, and the current efficiency was 93%. Further, generation of hydrogen and ammonia corresponding to the amounts of electrolytic reaction was recognized from the cathode generated gas during the electrolysis.

### Example 3

The energization was performed at an anode current density of 2.86 A/dm2 using the same device as in Example 1 and the same anode chamber feed solution composition and cathode chamber feed solution composition. The amount of charge transfer was 0.30 mol. After energization, the concentration of ammonium persulfate in the resulting anode produced solution was measured by titration. In the anode, 0.140 mol of ammonium persulfate was produced, and the current efficiency was 93%. Further, generation of hydrogen and ammonia corresponding to the amounts of electrolytic reaction was recognized from the cathode generated gas during the electrolysis.

### Example 4

A neutral alumina diaphragm was used as the diaphragm, and the other experimental device such as electrolyzer and the like and the anode chamber feed solution composition were the same as in Example 1. To the cathode chamber, 500 g of a 10 wt % ammonia aqueous solution was supplied. After supply, the energization was performed at an anode current density of 45 A/dm2. The amount of charge transfer was 0.67 mol. After energization, the concentration of ammonium persulfate in the resulting anode produced solution was measured by titration. In the anode, 0.295 mol of ammonium persulfate was produced, and the current efficiency was 88%. Further, generation of hydrogen and ammonia corresponding to the amounts of electrolytic reaction was recognized from the cathode generated gas during the electrolysis.

### Example 5

In the same device as in Example 1, ammonium sulfate containing an impurity produced as a byproduct in the lactam process was directly used to make the feed solution compositions for the anode chamber and the cathode chamber similar to in Example 1. The anode current density was 45 A/dm2, and electricity was applied to achieve the amount of charge transfer by which the concentration of ammonium persulfate in the anode produced solution became the same as in Example 1. The concentration of ammonium persulfate in the resulting anode produced solution was measured by titration. In the anode, 0.535 mol of ammonium persulfate was produced, and the current efficiency was 80%. The obtained anode produced solution was dehydrated and concentrated under reduced pressure while being stirred in a double-tube glass vessel to crystallize ammonium persulfate. The pressure in the glass vessel at the time of concentration was about 20 torr, the temperature of the contained solution was about 30° C., and the dehydration rate was 34.1%. The resulting slurry was filtered to separate it into mother liquid and cake, and the cake was further dried at a room temperature to obtain crystals of ammonium persulfate. When the purity of this ammonium persulfate crystal was determined, it was 98.4%. The mother liquid obtained by the filtration was added with an aqueous solution of ammonium sulfate produced as a byproduct in the lactam process by an equivalent amount of ammonium sulfate consumed in the electrolysis, and recycled as an anode chamber feed solution, and as the cathode chamber feed solution, the same one as in the previously performed first electrolysis was prepared separately. Electricity was applied under the same conditions as in the previously performed first electrolysis, and when the concentration of ammonium persulfate in the anode produced solution was measured, in the anode, 0.510 mol of ammonium persulfate was produced, and the current efficiency was 86%. When the obtained electrolytic solution was concentrated, dehydrated and crystallized in the same device and conditions as in the previously performed first crystallization, the dehydration rate was 25.9%, and the purity of ammonium persulfate crystal was 98.7%. Furthermore, the mother liquid was recycled by the same operation and the electrolysis and crystallization were performed twice, for a total of 4 cycles, and the current efficiency at the 4th cycle was 85%, the dehydration rate was 31.8%, and the purity of the ammonium persulfate crystal was 99.4%. Further, in each of the electrolysis, generation of hydrogen and ammonia corresponding to the amounts of electrolytic reaction was recognized from the cathode generated gas during the electrolysis.

### Comparative Example 1

Electrolysis of ammonium persulfate was carried out with the composition and the amount of charge transfer based on the description of JP-A-HEI 11-293484. The experimental device such as electrolyzer was the same as in Example 1. To the anode chamber, 500 g of an aqueous solution adding 0.05 wt % of guanidine sulfamate as a polarizer to a 43 wt % ammonium sulfate aqueous solution was supplied. As the substance mass of each ion, ammonium ion was 3.26 mol and sulfuric ion was 1.63 mol. To the cathode chamber, 500 g of aqueous solution of 18.9 wt % sulfuric acid and 28.4 wt % ammonium sulfate was supplied. As the substance mass of each ion, ammonium ion was 2.15 mol, sulfuric ion was 2.14 mol and hydrogen ion was 1.93mo1. The amount of current flow and the current flow time were then controlled so that the amount of charge transfer became 1.92 mol. After the energization, the composition of the solution in which the gas was collected with an excess of water from the anode produced solution, the cathode produced solution, and the cathode generation gas was analyzed by titration. On the anode side, 0.84 mol of ammonium persulfate was produced, and on the cathode side, 0.84 mol of ammonium sulfate and hydrogen corresponding to the amount of electrolytic reaction were produced and 0.84 mol of sulfuric acid was consumed, but no ammonia was produced. The current efficiency at that time was 87%.

### Industrial Applicability

Our method can produce ammonium persulfate with a high efficiency by electrolyzing ammonium sulfate as a feedstock, and can co-produce ammonia that can be effectively utilized for various processes without producing ammonium sulfate which is reused as in the conventional method, and can be applied extremely suitably to the production of ammonium persulfate required to efficiently consume ammonium sulfate that is excessively produced as a byproduct.

1-7. (canceled)

8. A method of producing ammonium persulfate by electrolyzing ammonium sulfate comprising:
providing an electrolyzer which is separated by a cation exchange membrane, supplying an ammonium sulfate aqueous solution as an anode-side feedstock, supplying a solution containing less than 1.0 mol of acid-derived acid dissociable hydrogen ions per 1.0 mol of amount of charge transfer, which is at least one selected from ammonium sulfate aqueous solution, ammonium hydroxide aqueous solution and 0.001 to 1% by weight of sulfuric acid aqueous solution, as a cathode-side feedstock, and performing electrolysis to produce ammonium persulfate on the anode side and at least ammonia on the cathode side.

9. The method according to claim 8, wherein the concentration of the ammonium sulfate aqueous solution as the anode-side feedstock is 30 to 45% by weight.

10. The method according to claim 8, wherein the cathode-side feedstock solution is an ammonium sulfate aqueous solution.

11. The method according to claim 10, wherein the concentration of the ammonium sulfate aqueous solution as the cathode-side feedstock is 30 to 45% by weight.

12. The method according to claim 8, further comprising adding a polarizer to the anode-side feedstock.

13. The method according to claim 12, wherein the polarizer is guanidine, guanidine salt or thiocyanate.

14. The method according to claim 8, wherein the anode is platinum, platinum group or a conductive diamond.

15. The method according to claim 8, wherein the ammonium persulfate is produced at a current efficiency of 80% or more.

16. The method according to claim 8, wherein the ammonium sulfate in the anode-side feedstock solution includes one produced as a byproduct in a lactam production process.

17. The method according to claim 8, wherein the ammonia produced on the cathode side is used for a lactam production process.
